(19) United States
(12) Patent Application Publication
(10) Pub. No.: US 2002/0159411 A1
(43) Pub. Date: Oct. 31, 2002

(54) Method and system for scheduling the transmission of wireless data

(76) Inventors: Manish Airy, San Jose, CA (US); Baraa Al-Dabagh, Sunnyvale, CA (US); Partho Mishra, Cupertino, CA (US); Huzur Saran, San Jose, CA (US)

Correspondence Address: Patent Department, Iospan Wireless, P.O. Box 641867, San Jose, CA, 95164-1867, US

(21) Appl. No.: 09/816,652

(22) Filed: Mar. 23, 2001

(51) Int. Cl. H04Q 7/00

(52) U.S. Cl. 370/330; 370/329

(57) ABSTRACT

A first embodiment of the invention includes a method for scheduling information in a multiple antenna wireless cellular network. The wireless cellular network includes a base transceiver station and a plurality of subscriber units wherein each of the plurality of subscriber units belongs to a service class. The method includes receiving a service flow request from a subscriber unit, determining the service class of the subscriber unit and scheduling time slots and frequency blocks for the service flow request based on the service class of the subscriber unit. A second embodiment of the present invention includes a system for scheduling the transmission of data in a multiple antenna wireless network. The system comprises means for receiving a service flow request from a subscriber unit, means for determining the service class of the subscriber unit and means for scheduling time slots and frequency blocks for the service flow request based on the service class of the subscriber unit. A third embodiment of the invention includes a computer readable medium containing program instructions for scheduling the transmission of data in a multiple antenna wireless network. The program instructions include receiving a service flow request from a subscriber unit, determining the service class of the subscriber unit and scheduling time slots and frequency blocks for the service flow request based on the service class of the subscriber unit.

### FIELD OF THE INVENTION

The invention relates generally to wireless communications. More particularly, the invention relates to scheduling of data wirelessly transmitted between a base control station having multiple antennas, and subscriber units.

### BACKGROUND OF THE INVENTION

Wireless communication systems commonly include information carrying modulated carrier signals that are wirelessly transmitted from a transmission source (for example, a base transceiver station) to one or more subscribers (for example, subscriber units) within an area or region.

### Spatial Multiplexing

Spatial multiplexing is a transmission technology that exploits multiple antennae at both the base transceiver station and at the subscriber units to increase the bit rate in a wireless radio link with no additional power or bandwidth consumption. Under certain conditions, spatial multiplexing offers a linear increase in spectrum efficiency with the number of antennae. The substreams occupy the same channel of a multiple access protocol, the same time slot in a time-division multiple access protocol, the same frequency slot in frequency-division multiple access protocol, the same code sequence in code-division multiple access protocol or the same spatial target location in space-division multiple access protocol. The substreams are applied separately to the transmit antennae and transmitted through a radio channel. Due to the presence of various scattering objects in the environment, each signal experiences multipath propagation.

The composite signals resulting from the transmission are finally captured by an array of receiving antennae with random phase and amplitudes. At the subscriber array, a spatial signature of each of the received signals is estimated. Based on the spatial signatures, a signal processing technique is applied to separate the signals, recovering the original substreams.

FIG. 1 shows three transmitter antenna arrays 110, 120, 130. The transmitter antenna arrays 110, 120, 130 transmit data symbols to a subscriber antenna array 140. Each transmitter antenna array includes spatially separate antennae. A subscriber connected to the subscriber antenna array 140 separates the received signals.

FIG. 2 shows modulated carrier signals traveling from a transmitter 210 to a subscriber 220 following many different (multiple) transmission paths.

Multipath can include a composition of a primary signal plus duplicate or echoed images caused by reflections of signals off objects between the transmitter and subscriber. The subscriber may receive the primary signal sent by the transmitter, but also receives secondary signals that are reflected off objects located in the signal path. The reflected signals arrive at the subscriber later than the primary signal. Due to this misalignment, the multipath signals can cause intersymbol interference or distortion of the received signal.

The actual received signal can include a combination of a primary signal and several reflected signals. Because the distance traveled by the original signal is shorter than the reflected signals, the signals are received at different times. The time difference between the first received and the last received signal is called the delay spread and can be as great as several microseconds.

The multiple paths traveled by the modulated carrier signal typically results in fading of the modulated carrier signal. Fading causes the modulated carrier signal to attenuate in amplitude when multiple paths subtractively combine.

### Communication Diversity

Antenna diversity is a technique used in multiple antenna-based communication system to reduce the effects of multi-path fading. Antenna diversity can be obtained by providing a transmitter and/or a subscriber with two or more antennae. These multiple antennae imply multiple channels that suffer from fading in a statistically independent manner. Therefore, when one channel is fading due to the destructive effects of multi-path interference, another of the channels is unlikely to be suffering from fading simultaneously. By virtue of the redundancy provided by these independent channels, a subscriber can often reduce the detrimental effects of fading.

The bandwidth of the available transmission frequencies is limited, therefore, wireless systems generally require the scheduling of information transmitted between base transceiver stations and subscriber units. The transmission between multiple transceiver stations and subscriber units generally requires time, frequency, or some other type of multiplexing. Consequently, the larger the number of base station transceivers and subscriber units, the more complex the scheduling. Additionally, the above-described spatial multiplexing and communication diversity add complexity to the scheduling.

Another factor that goes into the scheduling of information transmitted between base transceiver stations and subscriber units is the service class of the subscriber units. For example, subscriber units that handle voice and video data traffic require a guaranteed real time data rate, i.e. a constant bit rate (CBR). Additionally, subscriber units that handle Internet data traffic only need a best effort data rate, i.e. an unspecified bit rate (UBR).

For CBR service flows, the amount of bandwidth required by the subscriber unit is constant and does not change over time. However, for UBR service flows, the volume of traffic is typically bursty and unpredictable.

It is desirable to have a method and system that provides scheduling of transmission of data blocks between base station transceiver antennas and subscribers (subscriber) units. It is desirable that the scheduling be adaptive to the service class of each of the subscribers (subscriber) units. The present invention addresses such a need.

### SUMMARY OF THE INVENTION

The invention includes a method and system for scheduling wireless transmission of data blocks between at least one antenna of a base transceiver station and multiple subscriber units. The scheduling is preferably based in part on the service class of the subscriber units. The scheduling generally includes assigning frequency blocks and time slots to each of the subscriber units for receiving or transmitting data blocks.

A first embodiment of the invention includes a method for scheduling information in a multiple antenna wireless cellular network. The wireless cellular network includes a base transceiver station and a plurality of subscriber units wherein each of the plurality of subscriber units belongs to a service class. The method includes receiving a service flow request from a subscriber unit, determining the service class of the subscriber unit and scheduling time slots and frequency blocks for the service flow request based on the service class of the subscriber unit.

A second embodiment of the present invention includes a system for scheduling the transmission of data in a multiple antenna wireless network. The wireless cellular network includes a base transceiver station and a plurality of subscriber units wherein each of the plurality of subscriber units belongs to a service class. The system comprises a buffer for receiving a service flow request from a subscriber unit, means for determining the service class of the subscriber unit and means for scheduling time slots and frequency blocks for the service flow request based on the service class of the subscriber unit.

A third embodiment of the invention includes a computer readable medium containing program instructions for scheduling the transmission of data in a multiple antenna wireless network. The wireless cellular network includes a base transceiver station and a plurality of subscriber units wherein each of the plurality of subscriber units belongs to a service class. The program instructions include receiving a service flow request from a subscriber unit, determining the service class of the subscriber unit and scheduling time slots and frequency blocks for the service flow request based on the service class of the subscriber unit.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a prior art wireless system that includes spatially separate transmitters.

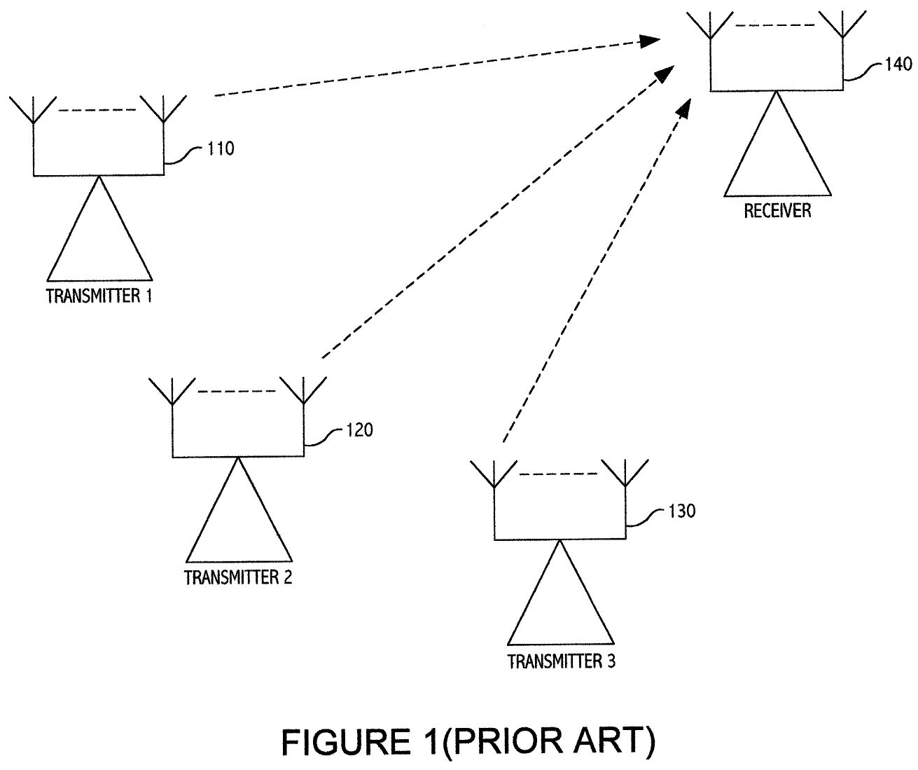

FIG. 2 shows a prior art wireless system that includes multiple paths from a system transmitter to a system subscriber.

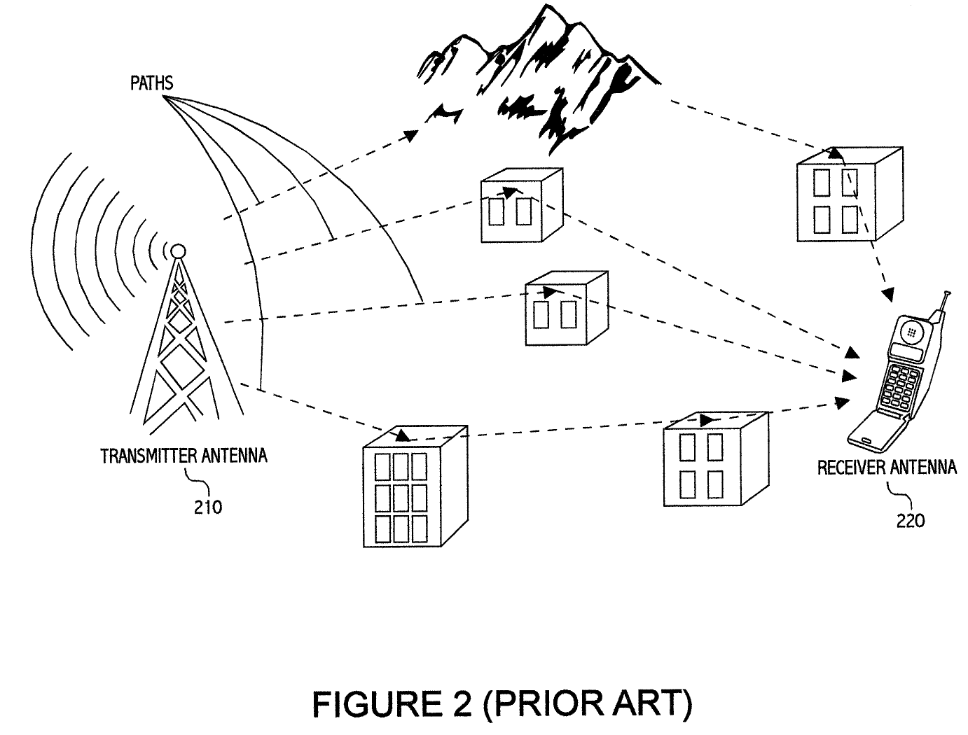

FIG. 3 shows an embodiment of the invention.

FIG. 4A shows a set of service flow requests that indicate demands for data by subscriber units.

FIG. 4B shows a set of estimated service flow buffer sizes that indicate demands for up link data by subscriber units.

FIG. 5A shows a frame structure depicting blocks of transmission data defined by transmission time and transmission frequency.

FIG. 5B shows a frame structure that includes an up link map transmitted at one frequency band, and a down link map transmitted at another frequency band.

FIG. 5C shows a frame structure that include an up link map transmitted at a first time, and a down link map transmitted at a second time.

FIG. 6 shows an example of a service flow table.

FIG. 7 depicts several modes of block transmission according to the invention.

FIG. 8 is a high level flowchart of the method in accordance with the present invention.

FIG. 9 is an example of a node tree that could be utilized by the scheduler in accordance with the present invention.

FIG. 10 is a sample node tree.

FIG. 11 is a flowchart of the CBR algorithm preferably utilized by the scheduler.

FIG. 12 is a flowchart of the UBR algorithm preferably utilized by the scheduler.

### DETAILED DESCRIPTION

The present invention relates to a method and system for scheduling wireless transmission of data blocks between at least one antenna of a base transceiver station and multiple subscriber units. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

As shown in the drawings for purposes of illustration, the invention is embodied in an apparatus and a method for scheduling wireless transmission of data blocks between at least one antenna of a base transceiver station and multiple subscriber units. The scheduling is preferably based in part on the service class of the subscriber units. The scheduling generally includes assigning frequency blocks and time slots to each of the subscriber units for receiving or transmitting data blocks.

As previously described, the invention includes wireless communication between at least one base transceiver station and subscriber units. The communications is two-way. That is, information is transmitted from the base transceiver station to the subscriber units (down link transmission), and information is transmitted from the subscriber units to the base transceiver station (up link transmission).

The transmission can be time division duplex (TDD). That is, the down link transmission can occupy the same channel (same transmission frequency) as the up link transmission, but occur at different times. Alternatively, the transmission can be frequency division duplex (FDD). That is, the down link transmission can be at a different frequency than the up link transmission. FDD allows down link transmission and up link transmission to occur simultaneously. The following discussion of the invention generally includes FDD. However, it should be understood that a TDD implementation is feasible.

As previously discussed, multiple subscriber units are in communication with at least once base transceiver station antenna. Multi-point wireless communication systems like this, can include time division multiplexing (TDM), frequency division multiplexing (FDM), code division multiplexing (CDM), spatial division multiplexing (SDM), or any combination thereof, for communicating with multiple units. The following discussion of the invention includes a TDM-FDM combination. However, it is to be understood that other combinations of the above describe multiplexing schemes can be implemented.

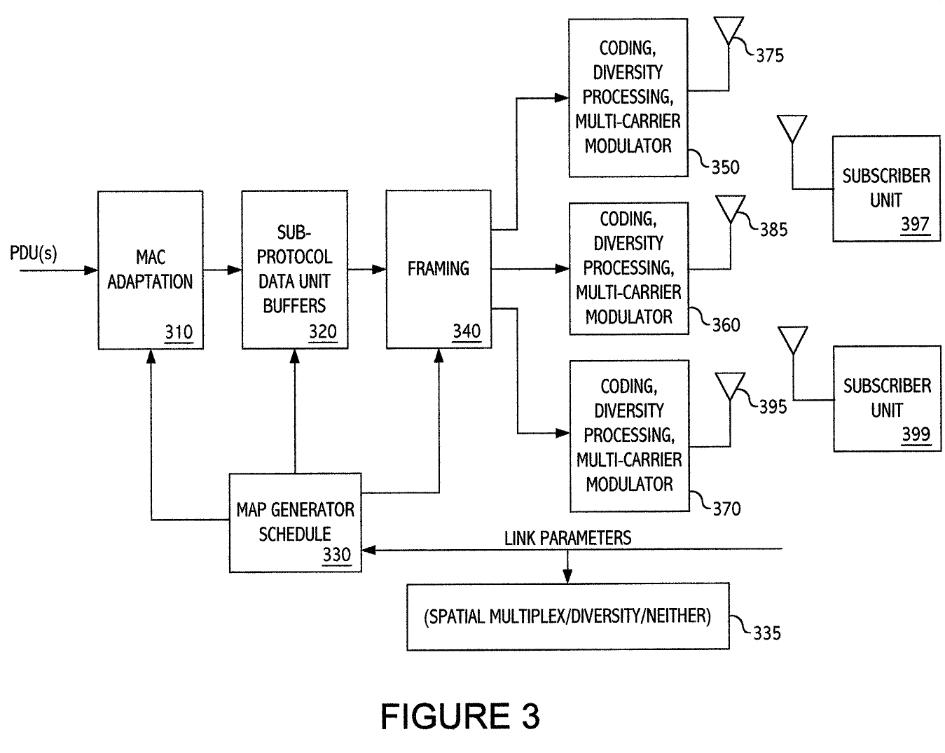

FIG. 3 shows an embodiment of the invention. The embodiment includes a base station transceiver receiving standard protocol data units (PDU's). The PDU's are divided into smaller sub-protocol data units that are stored in memory. A schedule is generated that designates time slots and frequency blocks in which the sub-protocol data units are to be transmitted to each of the subscriber units, and time slots and frequency blocks in which other sub-protocol data units are to be transmitted from the subscriber units to the base station transceiver based on service flow requests made by the subscriber units and the base station transceiver.

A media access control (MAC) adaptation unit 310 receives the protocol data units from a standard computer network. The protocol data units can be Ethernet or ATM frames, or Internet protocol (IP) or frame relay packets. The MAC adaptation unit 310 divides the protocol data units into smaller sub-protocol data units that are more adaptable for transmission within wireless communication systems. The smaller sub-protocol data units facilitate more efficient error recovery through retransmission. Wireless channels tend to vary often. The smaller size of the sub-protocol data units makes it more likely that the data units will experience a steady channel during transmission.

The digital circuitry or software required to divide or break large groups of data into smaller groups of data is well known in the art of digital circuit and software design.

The sub-protocol data units are stored within sub-protocol data buffers 320. The sub-protocol data buffers 320 provide a scheduler 330 with easy access to the sub-protocol data.

The scheduler 330 generates a map or schedule of when the sub-protocol data units are to be transmitted, which sub-protocol data units are to be received by which subscriber unit, and when and at what frequency band the subscriber units can transmit sub-protocol data units back to the base station transceiver. The map is transmitted to the subscriber units so that each subscriber unit knows when to receive and transmit sub-protocol units. A map is transmitted once per unit of time. The unit of time is generally referred to as a frame. The time duration of a frame is variable.

The scheduler 330 receives information regarding the service class of the subscriber units. Additionally, the scheduler 330 receives data requests from the subscriber units. The data requests include information regarding the size and data type of data to be transmitted. The scheduler then utilizes the data size, the data type and the designated service class of the subscriber units for generating the schedule.

The scheduling decisions that are based in part upon the designated service class of the subscriber units can be made at either the base station transceiver or the subscriber unit. The scheduling decisions can be made for both down link transmission and up link transmission. It is essential that both the base transceiver station and the subscriber unit be aware of the scheduling decisions that are made based upon the designated service class of the subscriber units.

The scheduler 330 accesses the sub-protocol data units within the sub-protocol data buffers 320. Each data request can have a dedicated buffer within the sub-protocol data buffers 320. A predetermined number of sub-protocol data units are retrieved by the scheduler 330 and ordered within a frame within a framing unit 340. A map of the schedule is included within every frame for the purpose of indicating to each subscriber unit when (that is, which time slot) and at what frequency data blocks requested by the subscriber unit will be transmitted, and when and at what frequency data blocks can be transmitted from the subscriber unit. The frame includes a predetermined number of sub-protocol data units as will be described later.

Multi-carrier modulator units 350, 360, 370 each generate a plurality of multiple-carrier modulated signals. Each multi-carrier modulator 350, 360, 370 receives a processed (coding and/or diversity processing) sub-protocol data unit stream and generates a multiple-carrier modulated signal based on the corresponding processed sub-protocol data unit stream. The multiple-carrier modulated signals are frequency up-converted and amplified as is well known in the art of communication systems.

An output of a first multi-carrier modulator 350 is connected to a first transmit antenna 375. An output of a second multi-carrier modulator 360 is connected to a second transmit antenna 385. An output of a third multi-carrier modulator 370 is connected to a third transmit antenna 395. The first transmit antenna 375, the second transmit antenna 385, and the third transmit antenna 395 can be located within an antenna array at a single base station. Alternatively, the first transmit antenna 375, the second transmit antenna 385, and the third transmit antenna 395 can each be located at separate base stations. The first transmit antenna 375, the second transmit antenna 385, and the third transmit antenna 395 can have different polarization states, and be either physically co-located at a single base station, or each located at separate base stations. Circuitry associated with the transmit chains can be separately located with the antennas 375, 385, 395.

The embodiment of FIG. 3 includes three transmit antennas. It is to be understood that the invention can include two or more transmit antennas. The additional antennas can be driven by additional multi-carrier modulators that each include separate corresponding processed sub-protocol data unit streams.

The embodiment of FIG. 3 can further include subscribers units 397, 399. The subscribers units 397, 399 can include multiple spatially separate subscriber antennae.

Multiple transmitter antennae and multiple subscriber antennae allow the wireless communication system to include spatial multiplexing and communication diversity. As described earlier, spatial multiplexing and communication diversity can improve the capacity of the communication system and reduce the effects of fading and multi-path resulting in increased capacity.

### Service Flows

A service flow request represents a bidirectional demand for data (up stream and down stream) between a base transceiver station and a subscriber unit, with an associated set of quality of service parameters. As previously mentioned, subscriber units that handle voice and video data traffic require a guaranteed real time data rate, i.e. a constant bit rate (CBR) and subscriber units that handle Internet data traffic only need a best effort data rate, i.e. an unspecified bit rate (UBR). For CBR service flows, the amount of bandwidth required by the subscriber unit is constant and does not change over time. However, for UBR service flows, the volume of traffic is typically bursty and unpredictable.

The CBR service flow requests include the scheduler scheduling the subscribers to receive or transmit sub-protocol data units periodically. The period can be a predetermined number of times per frame. Once a service flow request is made, the up link and down link bandwidth allocation is periodic. Information is transmitted to and from the subscriber units without the subscriber units having to send information size requests.

The UBR service flow requests include the scheduler scheduling the up link and down link scheduling based upon information size requests by the subscribers. The down link map allocations are made based upon the amount of data in the associated service flow buffers. The up link map allocations are made based upon the information size requests sent by the subscriber units. Each information size request updates the scheduler estimate of the amount of data in an associated service flow buffer.

The scheduler splits the available channel bandwidth between the CBR and UBR traffic types. Additionally, each traffic type could include a priority ranking, i.e. there can be multiple levels of priorities within each traffic type. For example, the UBR service class preferably comprises three priorities: Gold, Silver and Bronze (Gold being the highest, Bronze being the lowest).

The UBR service class priorities are preferably a function of how much a subscriber pays for the wireless service as well as the physical distance between the subscriber and the base transceiver station, i.e. a subscriber that is the requisite distance from the base transceiver station can subscribe to the Gold UBR service by paying a higher fee than she would for the silver or bronze service.

Although the invention is described in terms of incorporating the above described service class designations, one of ordinary skill in the art will readily recognize that a variety of service class designations could be incorporated within the present invention while remaining within the spirit and scope of the present invention.

### Down Link Service Flow Request

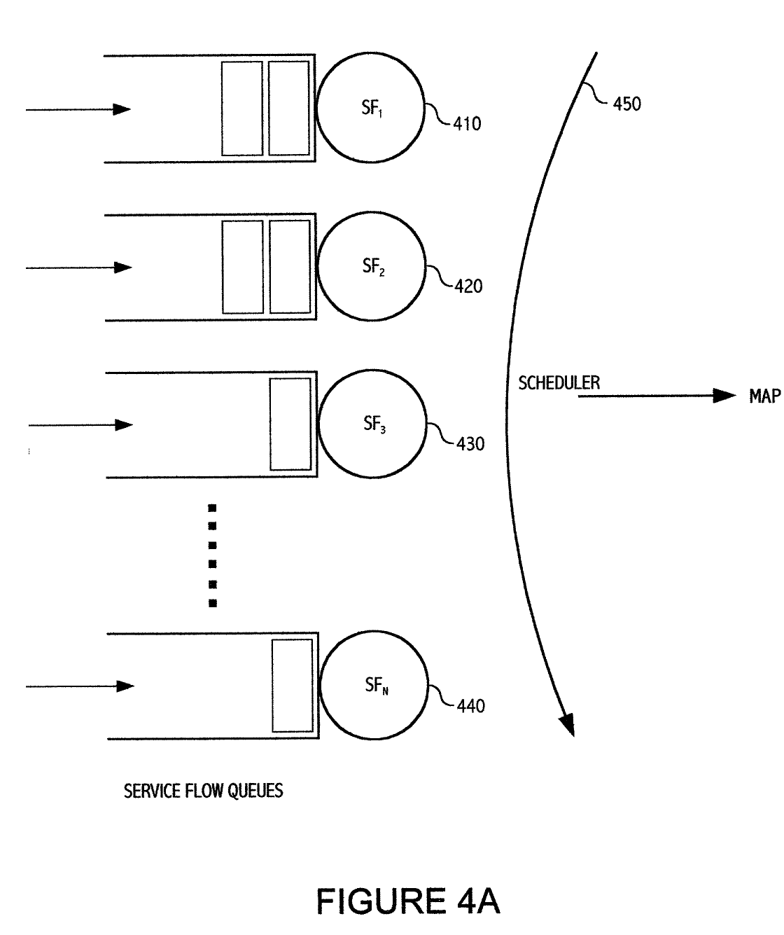

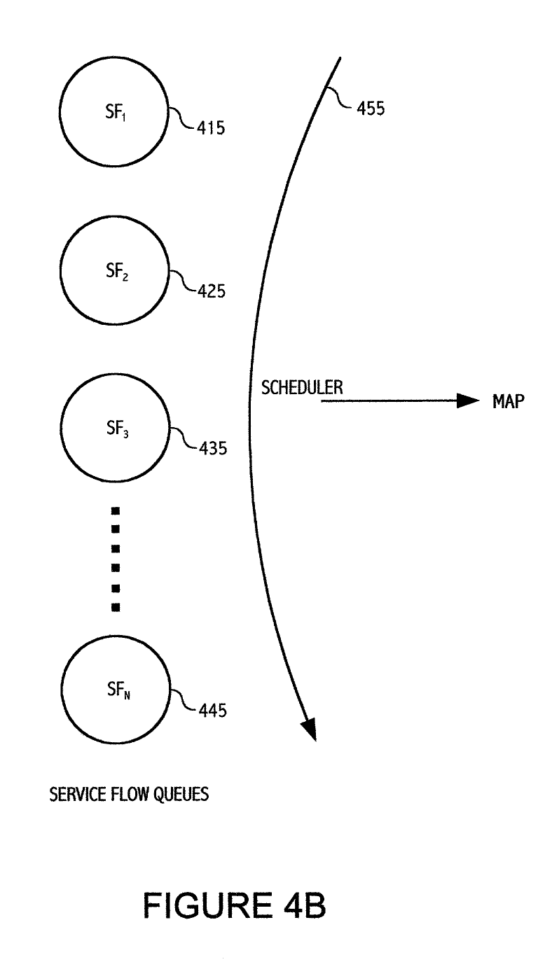

FIG. 4A shows a set of service flow buffers 410, 420, 430, 440 that contain sub-protocol data units for subscriber units. The scheduler uses the service flow buffers 410, 420, 430, 440 to generate the sub-protocol data transmission schedule. The service flow buffers can contain different sizes of data. The scheduler addresses the service flow buffers, and forms the schedule.

The service flow buffers 410, 420, 430, 440 contain data for the subscriber units. The buffers 410, 420, 430, 440 contain data received from the network generally in response to requests sent from the subscriber units. The buffers 410, 420, 430, 440 are accessible by a processor within the base transceiver station.

The service flow buffers 410, 420, 430, 440 can contain a variety of types, and amounts of data. As will be described later, these factors influence how the scheduler maps the data demanded by the subscriber units.

The scheduler accesses service flow buffers 410, 420, 430, 440, during the generation of the map of the schedule.

As depicted in FIG. 4A by arrow 450, an embodiment of the scheduler includes addressing each service flow sequentially and forming the map of the schedule. As will be described later, the data blocks dedicated to each service flow request is dependent upon a block weight. The block weight is generally dependent upon the priority of the particular demand for data.

### Up Link Service Flow Request

FIG. 4B shows a set of estimated service flow buffer sizes 415, 425, 435, 445 based upon the service flow (CBR, UBR) that indicate demands for up link data by subscriber units. The scheduler uses the estimated service flow buffer sizes 415, 425, 435, 445 to generate the sub-protocol data up link transmission schedule. The scheduler addresses the estimated service flow buffer sizes forming the schedule.

The estimated service flow buffer sizes 415, 425, 435, 445 are estimated demands for data by the subscriber units. The estimated service flow buffer sizes 415, 425, 435, 445 are generally wirelessly received from the subscriber units by the base transceiver station. The estimated service flow buffer sizes 415, 425, 435, 445 can be queued in memory buffers that are accessible by a processor within the base transceiver station.

As depicted in FIG. 4B by arrow 455, an embodiment of the scheduler includes addressing each estimated service flow buffer size sequentially and forming the map of the schedule. As will be described later, the data blocks dedicated to each estimated service buffer size is dependent upon a block weight. The block weight is generally dependent upon the priority of the particular demand for data.

### Frame Structure

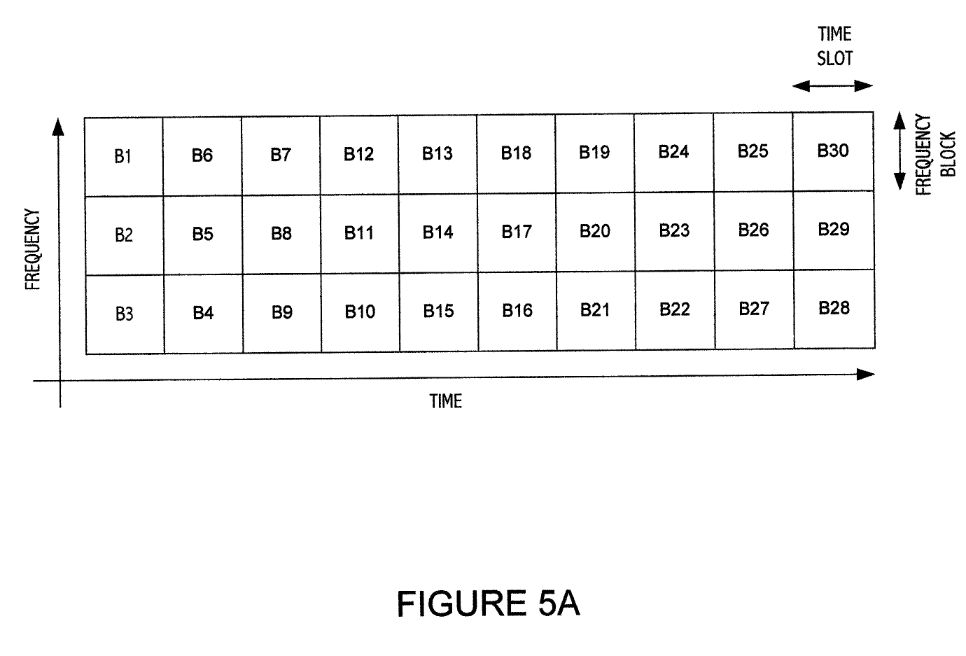

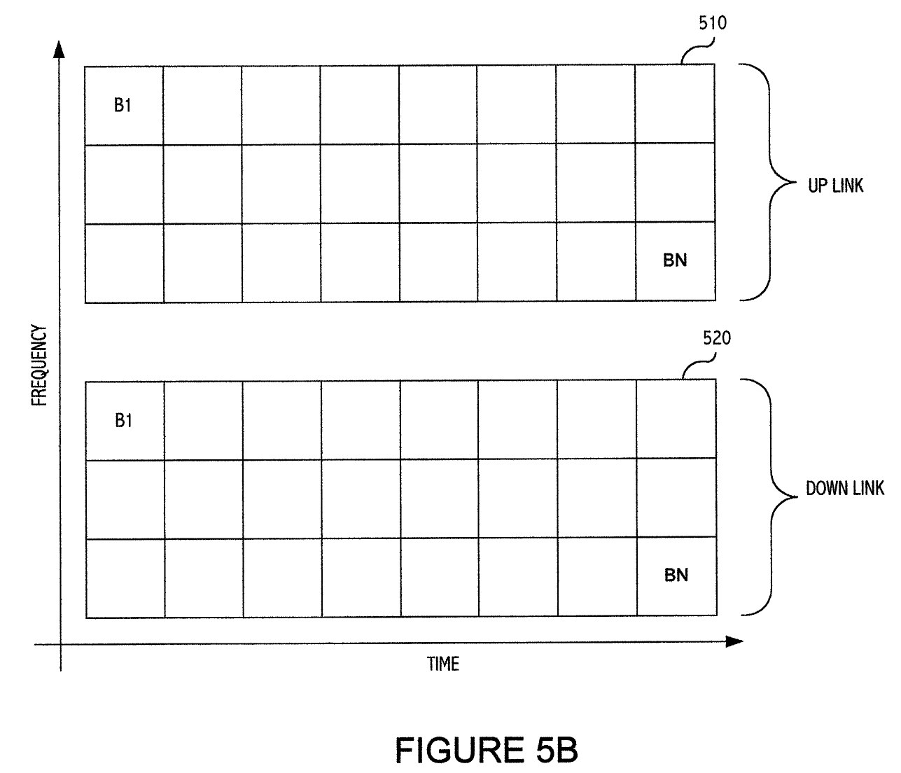

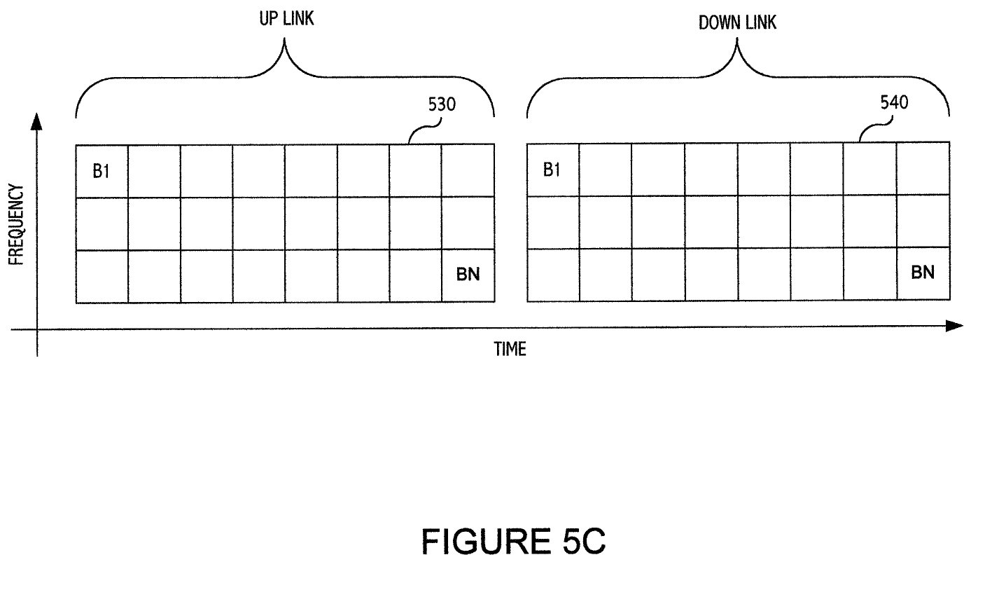

FIG. 5A shows a frame structure depicting blocks of transmission data defined by transmission time slots and transmission frequency blocks. The scheduler maps requests to transmit or receive data into such a frame structure. For example, data blocks B1, B2 and B3 can be transmitted during a first time slot, but over different frequency ranges or blocks. Data blocks B4, B5 and B6 are transmitted during a second time slot, but over different frequency ranges or blocks than each other. The different frequency ranges can be defined as different groupings or sets of Orthogonal Frequency Division Multiplexing symbols.

As depicted in FIG. 5A, the entire transmission frequency range includes three frequency blocks within a frame. Data blocks B1, B6, B7, B12, B13, B18, B19, B24, B25 and B30 are transmitted over common frequency ranges, but within different time slots. As depicted in FIG. 5A, ten time slots are included within a single frame. The number of time slots per frame is not necessarily fixed. The numbering of the data blocks is depicted in the order chosen because of ease of implementation.

FIG. 5B shows two frames 510, 520. A first frame 510 can be designated as the up link frame, and a second frame 520 can be designated as the down link frame. As shown in FIG. 5B, the up link frame 510 occupies a different frequency band than the down link frame 520. As described before, the frames include a finite number of frequency blocks and time slots. The frames 510, 520 of FIG. 5B are consistent with FDD transmission.

FIG. 5C also shows two frames 530, 540. A first frame 530 can be designated as the up link frame, and a second frame 540 can be designated as the down link frame. As shown in FIG. 5C, the up link frame 530 occupies a different time duration than the down link frame 540. As described before, the frames include a finite number of frequency blocks and time slots. The frames 530, 540 of FIG. 5C are consistent with TDD transmission.

### Service Flow Request Table

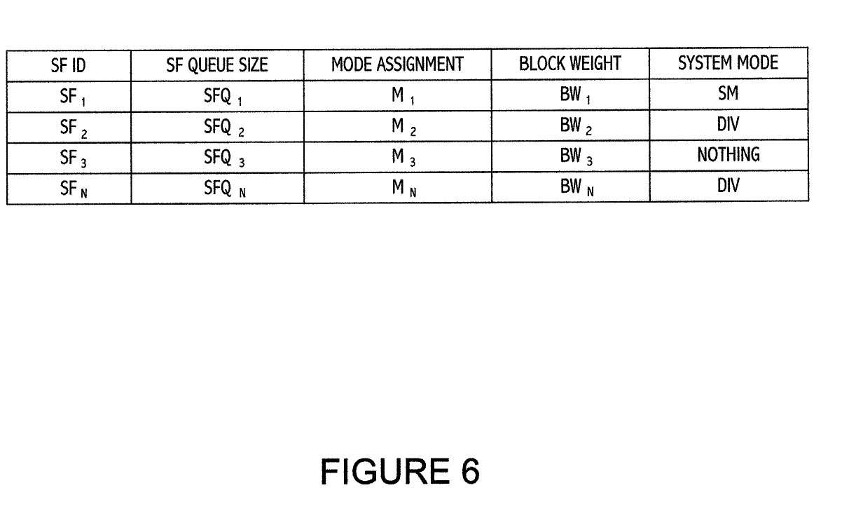

FIG. 6 shows an example of a service flow table. The service flow table depicts information about each service flow request that is useful in generating the data block transmission schedule. The information included within the service flow table includes a service flow request identification number (SF₁, SF₂, SF₃, SF_{N}), a service flow queue size (SFQ₁, SFQ₂, SFQ₃, SFQ_{N}), a mode assignment (M₁, M₂, M₃, M_{N}) a block weight (BW₁, BW₂, BW₃, BW_{N}), and system mode (SM, Diversity).

The service flow request identification number identifies each individual service flow request.

The service flow queue size provides information regarding the size or amount of information being requested by the service flow request.

The mode assignment provides information regarding the type of modulation and coding to be used when providing the data blocks of the service flow request. The mode assignment is generally determined by quality of the transmission link between the base station transceiver and the subscriber units.

The block weight determines the minimum number of previously described blocks that are allocated to a service flow request at a time. The block weight is generally determined according to the priority of the data being requested. That is, certain types of service flow requests are for higher priority information. By allocating a larger block weight, the service flow request will be satisfied more quickly.

For a service request having a block weight of two, for example, the mapping of the schedule will allocate two successive blocks to the service request. A larger block weight will cause a larger number of blocks to be allocated to a service request.

As previously described, the scheduler allocates bandwidth to the subscriber units based on the following hierarchy of service classes: CBR, UBR-Gold, UBR-Silver, UBR-Bronze. Accordingly, the scheduler creates service flow tables for each of the different service classes. The scheduler subsequently allocates time slots and frequency blocks for the CBR subscribers first and then allocates time slots and frequency blocks for the UBR subscribers.

### Transmission Modes

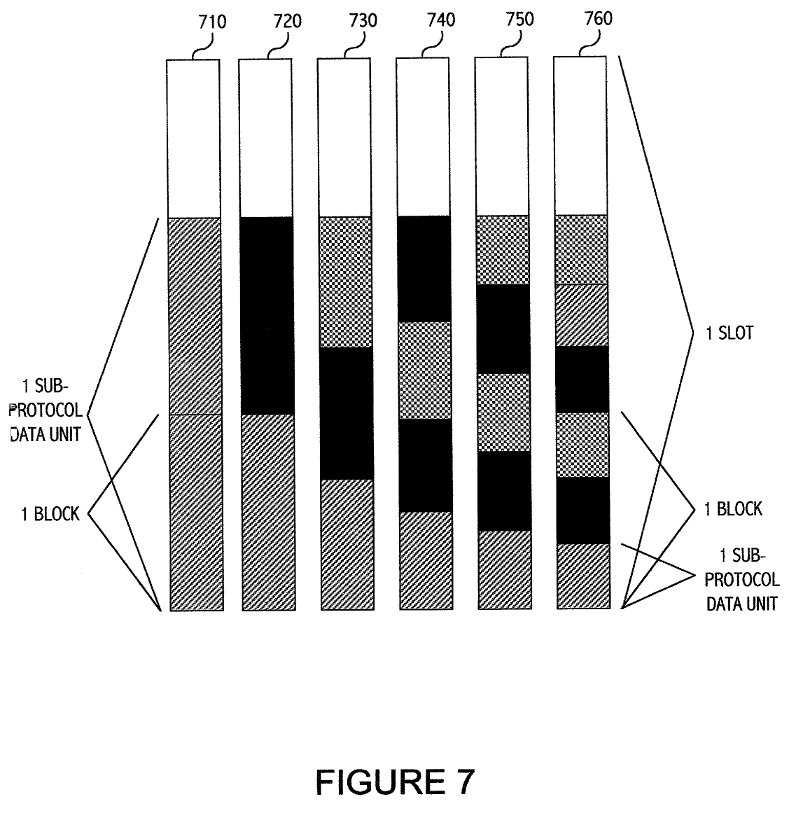

FIG. 7 depicts several modes of block transmission according to the invention. The mode selection is generally based upon the quality of the transmission link between the base station transceiver and the subscriber units. The mode selection can determine the type of modulation (for example, 4 QAM, 16 QAM or 64 QAM), the type of coding (convolution or Reed Solomon), or whether the transmission includes spatial multiplexing or diversity.

As previously stated, several transmission link parameters can be used to establish the mode associated with the transmission of a sub-protocol data unit requested by a service flow. FIG. 7 depicts a relationship between a transmission data block (defined by a frequency block and time slot) and sub-protocol data unit according to an embodiment of the invention.

FIG. 7 shows a single time slot that is divided into three data block for six different modes. A first mode 710 includes a sub-protocol data unit occupying two data blocks. A second mode 720 includes a sub-protocol data unit occupying a single data block. A third mode 730 includes three sub-protocol data units occupying two data blocks. A fourth mode 740 includes two sub-protocol data units occupying one data block. A fifth mode 750 includes five sub-protocol data units occupying two data blocks. A sixth mode 760 includes three sub-protocol data units occupying a single data block.

As previously stated, the mode assignment determines the amount of information transmitted within each data block. Generally, the better the quality of the transmission link between a base transceiver station and a subscriber unit, the higher the mode assignment, and the greater the amount of information transmitted per data block.

It should be understood that the mode assignment of transmission links between base transceiver stations and subscriber units can vary from subscriber unit to subscriber unit. It should also be understood that the mode assignment of a transmission link between a base transceiver station and a subscriber unit can change from time frame to time frame.

It is to be understood that the number of frequency blocks allocated per time slot is variable. An embodiment of the scheduler includes the scheduler taking into consideration constraints on the frequency bandwidth on either the up link or the down link transmission. The frequency bandwidth allocations can be adjusted by varying the number of frequency blocks within a time slot. The frequency bandwidth allocated to a subscriber can be limited due to signal to noise issues, or the Federal Communication Committee (FCC) limitations. The scheduler can account for these limitations though allocations of frequency bandwidth through the scheduling.

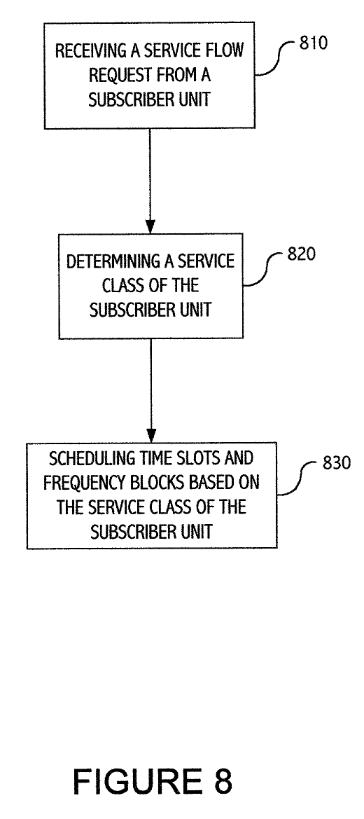

For a better understanding of the method in accordance with the present invention, please refer to FIG. 8. FIG. 8 shows a flow chart of steps involved in the implementation of the method in accordance with the present invention. As previously mentioned, the scheduler assigns time slots and frequency blocks in which sub-protocol data units are to be received by particular subscriber units. A schedule is generated once per a frame unit of time. A predetermined number of data blocks are included within a frame.

The scheduler is generally implemented in software that runs on the controller within the base transceiver station. The controller is generally electronically connected to the MAC adaptation unit, the sub-protocol data buffers and the framing unit.

Please refer now to FIG. 8. First, the scheduler receives a service flow request from a subscriber unit, via step 810. Next, the service class of the subscriber unit is determined, via step 820. Finally, time slots and frequency blocks are scheduled for the service flow request based on the service class of the subscriber unit, via step 830. Preferably, different algorithms are utilized to respectively schedule different classes of subscriber units, i.e. a first algorithm is utilized to schedule the CBR-subscriber units and a second algorithm is utilized to schedule the UBR-subscriber units.

### CBR Algorithm

In order to implement the CBR algorithm, a node tree must is utilized. The node tree is accordingly constructed based on a normalized rate requirement for the subscriber units within the CBR service class. For example, if there are 32 slots and subscriber unit number 1 needs 8 of those slots, the normalized rate is calculated as follows:

$$\frac{Number of slots needed}{Total number of slots} = \frac{8}{32} = \frac{1}{4}$$

Accordingly, the normalized rate for subscriber unit number 1 is ¼. This means that 1 in every 4 slots should be allocated to subscriber unit number 1.

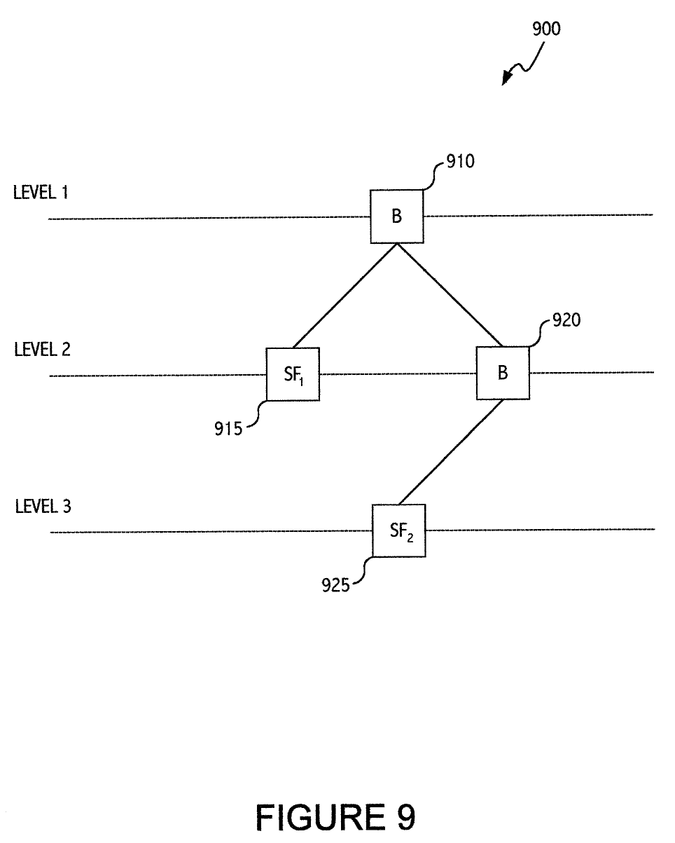

Please refer now to FIG. 9. FIG. 9 is an example of a node tree 900 that could preferably be utilized by the scheduler. The node tree comprises node bit components 910, 920 and service flow request components 915, 925. The node bit components 910, 920 are preferably units of memory that keep track of previously visited components and the service flow request components 915, 925 are service flow requests for associated subscriber units.

A node tree component that is on a level directly below another component is the child of that component. For example, service flow component 915 is the left child of node bit component 910 and node bit component 920 is the right child of node bit component 910.

The node tree 900 is utilized as follows. Starting with the first node bit component 910, the left child (service flow component 915) is visited. A slot is then assigned to the subscriber unit associated with the service flow component 915. Note, if the associated service flow component 915 is zero, then the slot is left open. The first node bit component 910 is then revisited. However, the node bit component 910 remembers that the left child was the child last visited so, the right child (node bit component 920) is visited. Note, if a node bit component is visited for the first time, it's left child will always be visited first. Accordingly, the left child (service flow component 925) is visited and a slot is assigned for the associated subscriber unit. The first node bit component 910 is then revisited and the process continues until all of the time slots are appropriately allocated.

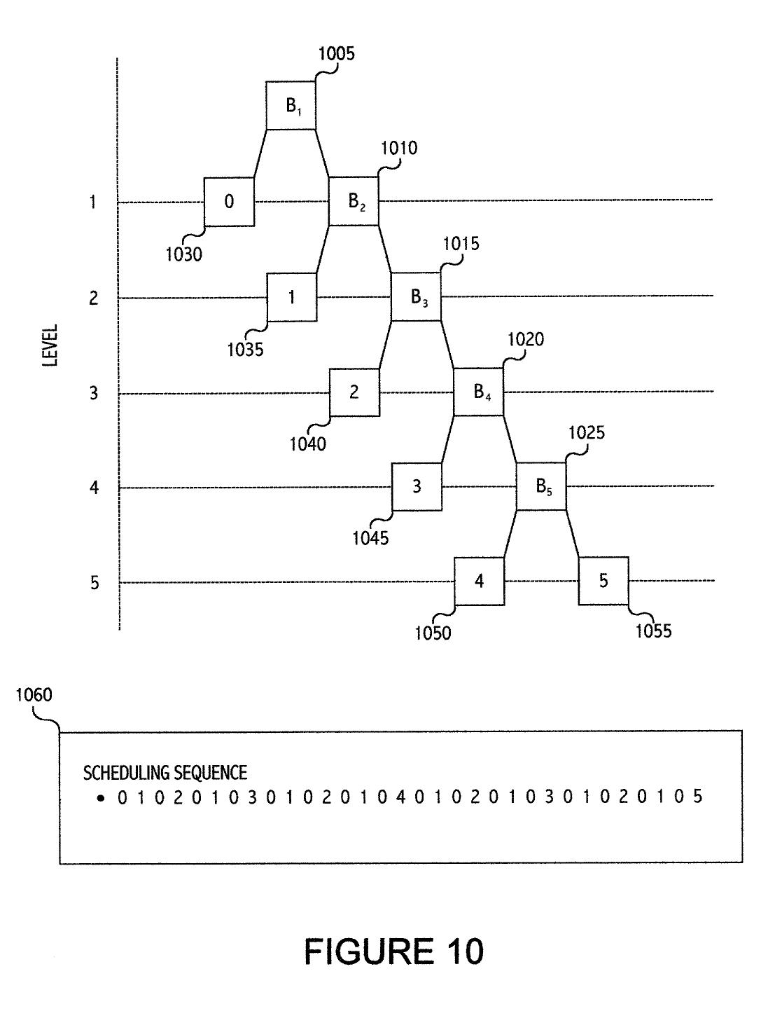

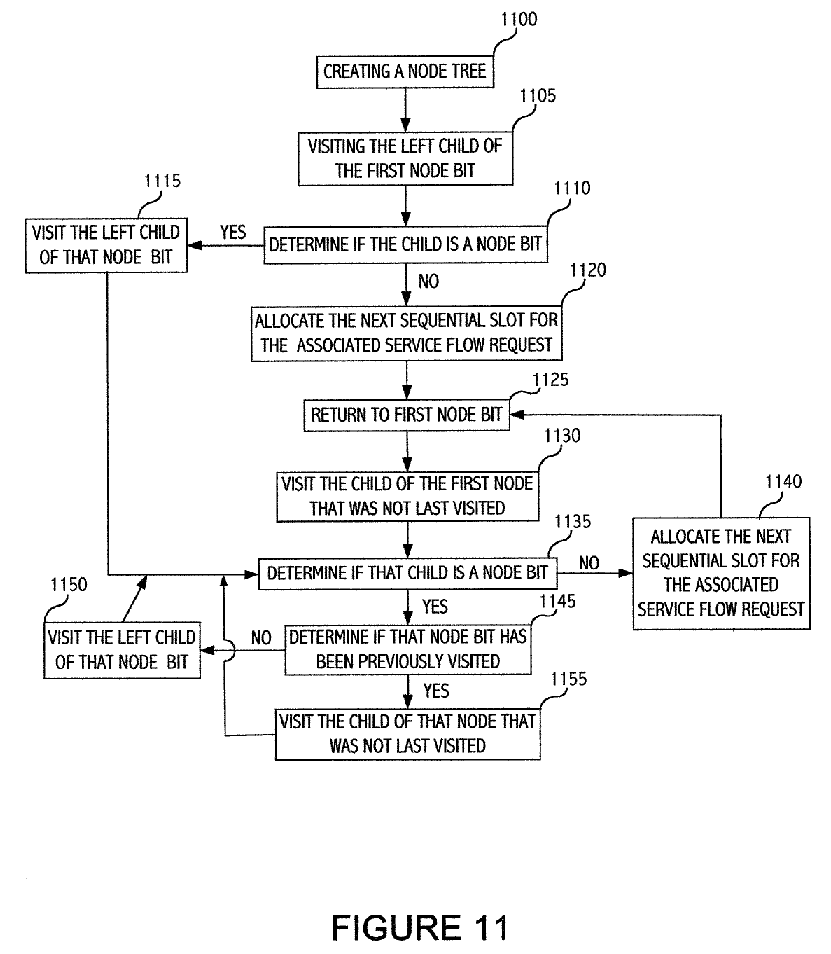

For a better understanding of the CBR algorithm, please refer to FIGS. 10 and 11. FIG. 10 is a sample node tree and FIG. 11 is a flowchart of the CBR algorithm preferably utilized by the scheduler.

FIG. 10 shows a five-level node tree 1000. Assume that there are 5 CBR-subscriber units and their respective normalized rates are ¼, ⅛, 1/16, 1/32, and 1/32. The node tree 1000 includes 5 node bit components 1005, 1010, 1015, 1020, 1025 and 5 service flow components 1035, 1040, 1045, 1050, 1055. A zero-component 1030 is utilized to notify the scheduler not to allocate the subsequent slot.

Please refer now to the flowchart of FIG. 11. First, a node tree is created, via step 1100. Preferably, the node tree comprises node bit components and service flow request components associated with all the subscriber units with a CBR designation. Next, the left child of the first node bit is visited, via step 1105. Next, a determination is made as to whether that child is a node bit, via step 1110. If that child is a node bit, than the left child of that node bit is visited, via step 1115. Proceed to step 1135. If that child is not a node bit, then the next sequential slot is allocated for the associated service flow request, via step 1120. If the service flow request is a zero-component the slot is left unallocated.

Next, return to first node bit, via step 1125. The child of the fist node that was not last visited is then visited, via step 1130. Next, a determination is made as to whether that child is a node bit, via step 1135. If that child isn't a node bit then the next sequential slot is allocated for the associated service flow request, via step 1140. If the service flow request is a zero-component the slot is left unallocated. Return to step 1125.

If that child is a node bit, a determination is made as to whether the node bit has been previously visited, via step 1145. If the node bit has not been previously visited, visit the left child of the node bit, via step 1150. Go to step 1135. If the node bit has been previously visited, the child that was not last visited is then visited, via step 1155. Go to step 1135.

The above-described algorithm is performed by the scheduler until all of the service flow requests for the CBR-subscriber units have been allocated. Accordingly, utilizing the algorithm in conjunction with FIG. 10, the scheduling sequence 1060 is achieved. Note, if the service flow requests for the CBR-subscriber units change i.e. a CBR-subscriber unit is added or deleted, the node tree is accordingly modified.

### UBR Algorithm

Once the CBR algorithm is completed and all of the service flow requests for the CBR-subscriber units have been allocated, the scheduler implements a second algorithm to allocate the service flow requests of the UBR-subscriber units to all of the remaining data blocks within the data frame.

The scheduler creates separate service flow requests tables for each UBR service class and preferably allocates the remaining data blocks within the data frame to the UBR-subscriber units based on the following service class hierarchy: UBR-Gold, UBR-Silver, UBR-Bronze. That is to say that the UBR-Gold subscriber units are serviced before the UBR-Silver subscriber units and the UBR-Silver subscriber units are serviced before the UBR-Bronze subscriber units.

Each UBR service flow request table is equipped with a pointer so that the scheduler can keep track of the service flow requests of the UBR-subscriber units that have been allocated in previous frames. In essence the scheduler “remembers” which UBR-subscriber unit service requests have been scheduled and which have not and schedules the subsequent frames accordingly.

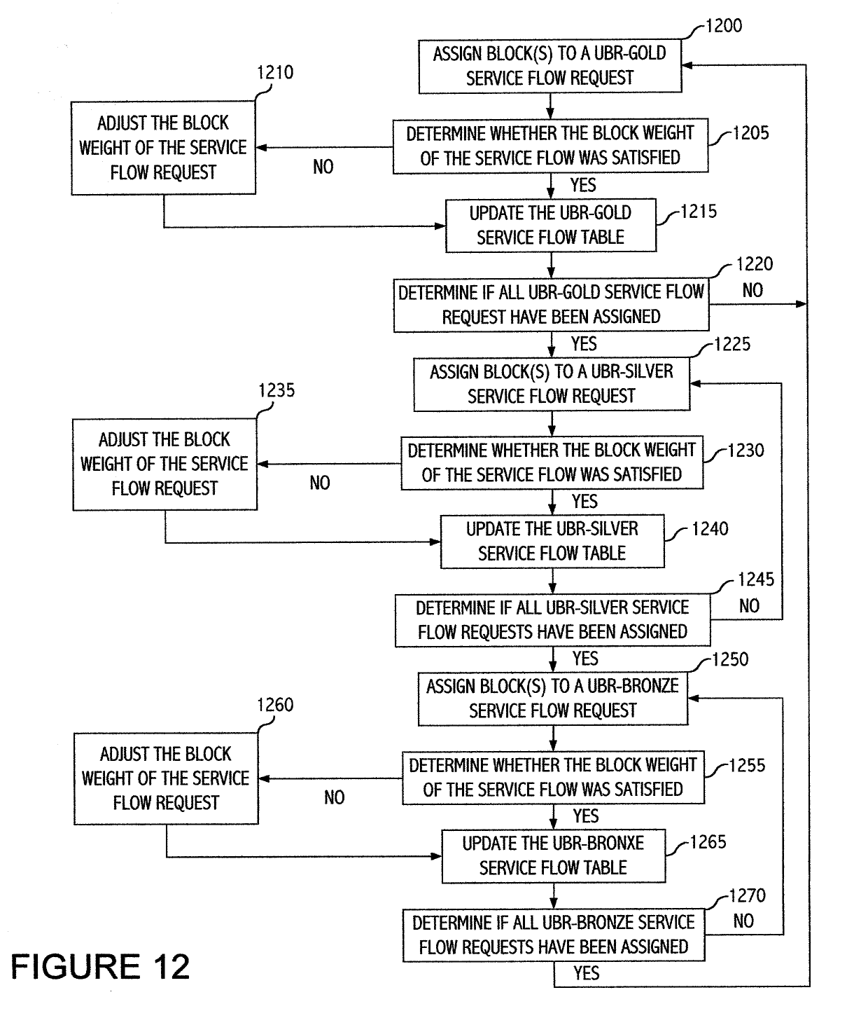

To further understand the UBR algorithm, please refer to FIG. 12. FIG. 12 is a flowchart of the UBR algorithm preferably utilized by the scheduler. First, time slots and frequency blocks are assigned to a UBR-Gold service flow request, via step 1200. Preferably, the service flow request contains information regarding the block weight of the request. Next, the scheduler determines whether the number of assigned time slots and frequency blocks equals the block weight of the UBR-Gold service flow request, via 1205.

If the number of assigned time slots and frequency blocks does not equal the block weight, the block weight of that particular service flow request is adjusted, via step 1210. Here, if the service flow request of a subscriber unit has a block weight of four (i.e. requires four time slots and frequency blocks) and only two time slot and frequency blocks can be allocated, the block weight of the service flow request is adjusted to six. In essence, the subscriber unit is “credited” with two time slots and frequency blocks. Accordingly, the next time the subscriber unit is serviced it will receive six time slots and frequency blocks instead of four. Additionally, if for any reason the number of assigned time slot and frequency blocks is more than the block weight, the block weight of the subscriber unit is reduced accordingly.

If the number of assigned time slots and frequency blocks equals the block weight, a UBR-Gold service flow table is updated, via step 1215. Preferably, each service flow table includes a pointer that can be moved by the scheduler so that the scheduler can “remember” which UBR-subscriber unit service requests have been scheduled and which have not. Next, the scheduler determines if all of the UBR-Gold service flow requests have been assigned, via step 1220. If all of the UBR-Gold service flow requests have not been assigned, return to step 1200. If all of the UBR-Gold service flow requests have been assigned, the scheduler assigns time slots and frequency blocks for a UBR-Silver service flow request, via step 1225.

Next, the scheduler determines whether the number of assigned time slots and frequency blocks equals the block weight of the UBR-Silver service flow request, via 1230. If the number of assigned time slots and frequency blocks does not equal the block weight, the block weight of that particular service flow request is adjusted, via step 1235.

If the number of assigned time slots and frequency blocks equals the block weight, the block weight of that particular service flow request is adjusted, a UBR-Silver service flow table is updated, via step 1240. Next, the scheduler determines if all of the UBR-Silver service flow requests have been assigned, via step 1245. If all of the UBR-Silver service flow requests have not been assigned, return to step 1225. If all of the UBR-Silver service flow requests have been assigned, the scheduler assigns time slots and frequency blocks for a UBR-Bronze service flow request, via step 1250.

Next, the scheduler determines whether the number of assigned time slots and frequency blocks equals the block weight of the UBR-Bronze service flow request, via 1255. If the number of assigned time slots and frequency blocks does not equal the block weight, the block weight of that particular service flow request is adjusted, via step 1260.

If the number of assigned time slots and frequency blocks equals the block weight, the block weight of that particular service flow request is adjusted, a UBR-Bronze service flow table is updated, via step 1265. Next, the scheduler determines if all of the UBR-Bronze service flow requests have been assigned, via step 1270. If all of the UBR-Bronze service flow requests have not been assigned, return to step 1255. If all of the UBR-Bronze service flow requests have been assigned, return to step 1200.

It should be noted that in order to prevent service classes from receiving more than their fair share of bandwidth allocation, a predetermined maximum number of time slots and frequency blocks of each frame could be reserved for each service class, e.g. a maximum number of blocks could be reserved for the CBR subscribers, another number of blocks are reserved for the UBR-Gold subscribers, etc. Accordingly, if the maximum number of blocks of a particular service class are not used, the scheduler could allocate those unused blocks to lower class subscribers.

### Rate Limiting

For UBR subscribers, rate limiting is enforced to prevent a user from using available bandwidth in excess of a predetermined transmission threshold. For instance, UBR-Gold subscribers, could preferably have transmission threshold of up to 4 Mbps over any 1 second window, UBR-Silver subscribers could have a transmission threshold of 1 Mbps, etc. Each transmission threshold can be adjusted by a system operator and the scheduler subsequently enforces the threshold.

The invention includes a method and system for scheduling wireless transmission of data blocks between at least one antenna of a base transceiver station and multiple subscriber units. The scheduling is preferably based in part on the service class of the subscriber units. The scheduling generally includes assigning frequency blocks and time slots to each of the subscriber units for receiving or transmitting data blocks.

Although the present invention has been described in accordance with the embodiments shown, one of ordinary skill in the art will readily recognize that there could be variations to the embodiments and those variations would be within the spirit and scope of the present invention. Accordingly, many modifications may be made by one or ordinary skill in the art without departing from the spirit and scope of the appended claims.

what is claimed:

1. A method for scheduling information in a multiple antenna wireless cellular network, the wireless cellular network comprising a base transceiver station and a plurality of subscriber units wherein each of the plurality of subscriber units belongs to a service class, the method comprising:
receiving a service flow request from a subscriber unit;
determining the service class of the subscriber unit; and
scheduling time slots and frequency blocks for the service flow request based on the service class of the subscriber unit.

2. The method of claim 1 wherein the service class comprises a priority ranking.

3. The method of claim 2 wherein scheduling time slots and frequency blocks for the service flow request based on the service class of the subscriber unit further comprises:
scheduling time slots and frequency blocks for the service flow request based on the service class and the priority ranking of the subscriber unit.

4. The method of claim 2 wherein the service class comprises more than one service class and scheduling time slots and frequency blocks for the service flow request based on the service class of the subscriber unit further comprises:
utilizing a different algorithm to schedule the time slots and frequency blocks for each service class.

5. The method of claim 4 further comprising:
utilizing a first algorithm to schedule time slots and frequency blocks for a first service class.

6. The method of claim 5 further wherein utilizing the first algorithm to schedule time slots and frequency blocks for the first service class comprises:
creating a node tree; and
implementing the first algorithm via the node tree.

7. The method of claim 6 wherein the first service class comprises subscriber units requiring a guaranteed real-time data rate.

8. The method of claim 5 further comprising:
utilizing a second algorithm to schedule time slots and frequency blocks for a second service class.

9. The method of claim 8 wherein utilizing the second algorithm to schedule time slots and frequency blocks for the second service class comprises:
1) scheduling time slots and frequency blocks for the service flow request of a subscriber unit of a particular priority of the second service class based on a block weight of the service flow request;
2) determining whether the number of scheduled time slots and frequency blocks equals the block weight of the service flow request;
3) adjusting the block weight of the service flow request if the number of scheduled time slots and frequency blocks does not equal the block weight of the service flow request;
4) repeating steps 1-3 for a subsequent service flow request of a subscriber unit of the particular priority of the second service class.

10. The method of claim 9 wherein adjusting the block weight of the service flow request comprises increasing the block weight if the number of scheduled time slots and frequency blocks is less than the block weight and decreasing the block weight if the number of scheduled time slots and frequency blocks is more than the block weight.

11. The method of claim 10 wherein the second service class comprises subscriber units requiring a best effort data rate.

12. The method of claim 11 wherein subscriber units in the second service class transmit data based on a predetermined transmission threshold.

13. A system for scheduling information in a multiple antenna wireless cellular network, the wireless cellular network comprising a base transceiver station and a plurality of subscriber units wherein each of the plurality of subscriber units belongs to a service class, the system comprising:
means for receiving a service flow request from a subscriber unit;
means for determining the service class of the subscriber unit; and
means for scheduling time slots and frequency blocks for the service flow request based on the service class of the subscriber unit.

14. The system of claim 13 wherein the service class comprises a priority ranking.

15. The system of claim 14 wherein the means for scheduling time slots and frequency blocks for the service flow request based on the service class of the subscriber unit further comprises:
means for scheduling time slots and frequency blocks for the service flow request based on the service class and the priority ranking of the subscriber unit.

16. The system of claim 14 wherein the service class comprises more than one service class and the means for scheduling time slots and frequency blocks for the service flow request based on the service class of the subscriber unit further comprises:
means for utilizing a different algorithm to schedule the time slots and frequency blocks for each service class.

17. The system of claim 15 further comprising:
means for utilizing a first algorithm to schedule time slots and frequency blocks for a first service class.

18. The system of claim 17 wherein the means for utilizing the first algorithm to schedule time slots and frequency blocks for the first service class comprises:
means for creating a node tree; and
means for implementing the first algorithm via the node tree.

19. The system of claim 18 wherein the first service class comprises subscriber units requiring a guaranteed real-time data rate.

20. The system of claim 16 further comprising:
means for utilizing a second algorithm to schedule time slots and frequency blocks for a second service class.

21. The system of claim 20 wherein the means for utilizing the second algorithm to schedule time slots and frequency blocks for the second service class comprises:
means for scheduling time slots and frequency blocks for the service flow request of a subscriber unit of a particular priority of the second service class based on a block weight of the service flow request;
means for determining whether the number of scheduled time slots and frequency blocks equals the block weight of the service flow request; and
means for adjusting the block weight of the service flow request if the number of scheduled time slots and frequency blocks does not equal the block weight of the service flow request.

22. The system of claim 21 wherein the means for adjusting the block weight of the service flow request comprises increasing the block weight if the number of scheduled time slots and frequency blocks is less than the block weight and decreasing the block weight if the number of scheduled time slots and frequency blocks is more than the block weight.

23. The system of claim 22 wherein the second service class comprises subscriber units requiring a best effort data rate.

24. The system of claim 23 wherein subscriber units in the second service class transmit data based on a predetermined transmission threshold.

25. A computer readable medium containing program instructions for scheduling information in a multiple antenna wireless cellular network, the wireless cellular network comprising a base transceiver station and a plurality of subscriber units wherein each of the plurality of subscriber units belongs to a service class, the program instructions comprising:
receiving a service flow request from a subscriber unit;
determining the service class of the subscriber unit; and
scheduling time slots and frequency blocks for the service flow request based on the service class of the subscriber unit.

26. The computer readable medium of claim 25 wherein the service class comprises a priority ranking.

27. The computer readable medium of claim 26 wherein scheduling time slots and frequency blocks for the service flow request based on the service class of the subscriber unit further comprises:
scheduling time slots and frequency blocks for the service flow request based on the service class and the priority ranking of the subscriber unit.

28. The computer readable medium of claim 26 wherein the service class comprises more than one service class and scheduling time slots and frequency blocks for the service flow request based on the service class of the subscriber unit further comprises:
utilizing a different algorithm to schedule the time slots and frequency blocks for each service class.

29. The computer readable medium of claim 28 further comprising:
utilizing a first algorithm to schedule time slots and frequency blocks for a first service class.

30. The computer readable medium of claim 29 further wherein utilizing the first algorithm to schedule time slots and frequency blocks for the first service class comprises:
creating a node tree; and
implementing the first algorithm via the node tree.

31. The computer readable medium of claim 30 wherein the first service class comprises subscriber units requiring a guaranteed real-time data rate.

32. The computer readable medium of claim 28 further comprising:
utilizing a second algorithm to schedule time slots and frequency blocks for a second service class.

33. The computer readable medium of claim 32 wherein utilizing the second algorithm to schedule time slots and frequency blocks for the second service class comprises:
1) scheduling time slots and frequency blocks for the service flow request of a subscriber unit of a particular priority of the second service class based on a block weight of the service flow request;
2) determining whether the number of scheduled time slots and frequency blocks equals the block weight of the service flow request;
3) adjusting the block weight of the service flow request if the number of scheduled time slots and frequency blocks does not equal the block weight of the service flow request;
4) repeating steps 1-3 for a subsequent service flow request of a subscriber unit of the particular priority of the second service class.

34. The computer readable medium of claim 33 wherein adjusting the block weight of the service flow request comprises increasing the block weight if the number of scheduled time slots and frequency blocks is less than the block weight and decreasing the block weight if the number of scheduled time slots and frequency blocks is more than the block weight.

35. The computer readable medium of claim 34 wherein the second service class comprises subscriber units requiring a best effort data rate.

36. The computer readable medium of claim 35 wherein subscriber units in the second service class transmit data based on a predetermined transmission threshold.

37. A scheduler for scheduling information in a multiple antenna wireless cellular network, the wireless cellular network comprising a base transceiver station and a plurality of subscriber units wherein each of the plurality of subscriber units belongs to a service class, the scheduler comprising:
a buffer for receiving a service flow request from a subscriber unit; and
a processor for determining the service class of the subscriber unit and scheduling time slots and frequency blocks for the service flow request based on the service class of the subscriber unit.

38. The scheduler of claim 37 wherein the service class comprises a priority ranking.

39. The scheduler of claim 38 wherein the processor further comprises:
means for scheduling time slots and frequency blocks for the service flow request based on the service class and the priority ranking of the subscriber unit.

40. The scheduler of claim 39 wherein the service class comprises more than one service class and the processor further comprises:
means for utilizing a different algorithm to schedule the time slots and frequency blocks for each service class.

41. The scheduler of claim 40 wherein the processor further comprises:
means for utilizing a first algorithm to schedule time slots and frequency blocks for a first service class; and
means for utilizing a second algorithm to schedule time slots and frequency blocks for a second service class.
